(19) United States
(12) Patent Application Publication
(10) Pub. No.: US 2020/0038925 A1
(43) Pub. Date: Feb. 6, 2020

(54) APPARATUS FOR TREATING MIXED WASTE AND METHOD THEREOF

(71) Applicant: TRIA PTE. LTD., Singapore (SG)

(72) Inventors: Meng Chong TAN, Singapore (SG); Pei Kang NG, Singapore (SG)

(21) Appl. No.: 16/604,085

(22) PCT Filed: Apr. 14, 2017
(86) PCT No.: PCT/SG2017/050212

§ 371 Date: Oct. 9, 2019

(51) Int. Cl. B09B 3/00; B01J 19/20; B01J 19/12

(52) U.S. Cl. CPC B09B 3/0083; B01J 2219/00184; B01J 19/123; B01J 19/20

(57) ABSTRACT

The present invention relates to an apparatus for treating mixed waste, for example, an apparatus for degrading bioplastic material in the mixed waste. The apparatus includes an electromagnetic wave emitter adapted to emit an electromagnetic wave on to the mixed waste; a movement inducing device adapted to move the mixed waste when the electromagnetic wave is being emitted onto the mixed waste such that the mixed waste is moved to increase the exposure of the mixed waste to the electromagnetic wave; and at least one of a heat emitter adapted to emit heat and a moisture emitter adapted to emit moisture onto the mixed waste. The present invention further relates to a method of treating mixed waste.

### FIELD OF INVENTION

The present invention relates to an apparatus for treating mixed waste and an a method thereof. For example, an apparatus for degrading bioplastic material in the mixed waste.

### BACKGROUND

The use of bioplastic, such as polylactic acid (PLA), and polylactide aliphatic copolymer (CPLA), has been on the rise in recent years. Bioplastic has been used widely for single-use consumables like coffee pods, water bottles, food packaging and disposable cutleries. Its popularity is much credited to the notion that these bioplastics are compostable and can be degraded in a short amount of time as opposed to plastic, hence does not pollute the environment. But in reality, bioplastic waste can take up to tens of years to compost in the natural environment if the climatic environment is not conducive.

Despite its mass adoption, there is a lack of appropriate waste management for bioplastic waste. Most bioplastic waste end up in landfill, in which they do not degrade any better than the plastic waste. Some of the bioplastic waste are sent to standard materials recovery facility only to be removed from the process, because bioplastic is a contaminant in plastic recycling operations. While some others are incinerated, which questions the purpose of its compostability.

For bioplastics waste that makes it to commercial composting sites, it takes a long time to compost, e.g. up to 6 months, which consequently results in the bioplastic waste being piled up over time and requiring large land areas and prohibitive resource cost to manage. Thus, it is no uncommon that many commercial sites refuse to accept bioplastic waste.

There are existing methods to degrade bioplastic materials. Such methods comprise largely of biological means through microorganism, bacterial strains and enzymes. On its own, biological degradation process can takes months. There are non-biological methods that the use of solvent solutions to chemically degrade bioplastic material. While effective, it relies heavily on the purity of the feedstock, which is often not the case since bioplastic wastes usually come mixed with other wastes.

Therefore, it is beneficial to find a solution to the abovementioned problems.

### SUMMARY

According to various embodiments, the present invention relates to an apparatus for treating mixed waste. The apparatus includes an electromagnetic wave emitter adapted to emit an electromagnetic wave on to the mixed waste; a movement inducing device adapted to move the mixed waste when the electromagnetic wave is being emitted onto the mixed waste such that the mixed waste is moved to increase the exposure of the mixed waste to the electromagnetic wave; and at least one of a heat emitter adapted to emit heat and a moisture emitter adapted to emit moisture onto the mixed waste.

According to various embodiments, the movement inducing device may include a rotatable shaft adapted to rotate about a rotational axis and at least one stirring element extending from the rotatable shaft, such that the stirring element may be adapted to stir the mixed waste.

According to various embodiments, the stirring element may include a helical fin extending from the shaft along the rotational axis.

According to various embodiments, the heat emitter and the moisture emitter may be combined as a pressurized heated moisture emitter adapted to emit pressurized heated moisture onto the mixed waste.

According to various embodiments, the electromagnetic wave emitter may include a UV emitter.

According to various embodiments, the electromagnetic wave may have a wavelength of 100-280 nm.

According to various embodiments, the apparatus may be adapted to emit the electromagnetic wave onto the mixed waste for up to 12 hours.

According to various embodiments, the apparatus may be adapted to emit heat to maintain the mixed waste at a temperature range from 60° C. to 100° C.

According to various embodiments, the apparatus may include a chamber having a top portion, a bottom portion opposite the top portion and a centre portion between the top portion and the bottom portion, such that the electromagnetic wave emitter may be disposed within the chamber at the top portion of the chamber and the stirring device may be disposed within the chamber at the centre portion or bottom portion.

According to various embodiments, the chamber may have a reflective internal surface adapted to reflect the electromagnetic wave.

According to various embodiments, the at least one of the heat emitter and moisture emitter are disposed within the chamber.

According to various embodiments, moisture may be emitted to maintain a relative humidity of 70% to 100% in the chamber.

According to various embodiments, the apparatus may further include a shredder adapted to shred the mixed waste.

According to various embodiments, the present invention further relates to a method of treating mixed waste in an apparatus. The method includes emitting an electromagnetic wave on the mixed waste; moving the mixed waste when the electromagnetic wave is being emitted onto the mixed waste such that moving the mixed waste increase its exposure to the electromagnetic wave; and emitting at least one of heat and moisture onto the mixed waste.

According to various embodiments, the emission of the heat and moisture may be combined, such that the method may include emitting pressurized heated moisture.

According to various embodiments, the electromagnetic wave may be UV.

According to various embodiments, the electromagnetic wave may have a wavelength of 100-280 nm.

According to various embodiments, the electromagnetic wave may be emitted onto the mixed waste for up to 12 hours.

According to various embodiments, the heat may be emitted to maintain the mixed waste at a temperature range from 60° C. to 100° C.

According to various embodiments, the apparatus may include a chamber, such that moisture may be emitted to maintain the chamber at a relative humidity of 70% to 100%.

According to various embodiments, the method may further include shredding the mixed waste before emitting the electromagnetic wave and stirring the mixed waste.

The current invention comprises a method and an apparatus to accelerate the degradation of mixed waste. Specifically, the current invention aims to accelerate the degradation of the bioplastic in the mixed waste, which may be mixed with other organic waste, prior to a biological degradation process (composting). This will accelerate the degradation of bioplastics significantly to shorten the total composting time. The invention takes into consideration that bioplastic waste is likely to be mixed with other organic waste such as food waste and paper scraps. The method involves at least one of the steps of putting the bioplastic waste mix through mechanical shredding, photodegradation coupled with moving of the bioplastic waste mix, thermal degradation and hydrolysis.

The apparatus and method are suitable for the treatment of any waste that is organic in nature, i.e. organic waste. Applications may include the treatement of food waste, e.g. from homes and restaurants, and/or agriculture waste, e.g. animal manure, horticulture waste Typically, such wastes include bioplastic material, e.g. bags. Therefore, it would be advantages to use the apparatus and method of the present invention to accelerate the degradation of such waste.

### BRIEF DESCRIPTION OF DRAWINGS

FIG. 1A shows a side sectional view of an example of an apparatus for treating mixed waste.

FIG. 1B shows a frontal sectional view of an example of the apparatus in FIG. 1A.

FIG. 2 shows a flow diagram of a method for treating mixed waste with bioplastic material.

FIG. 3 shows a side sectional view of an example of the apparatus.

FIG. 4 shows a schematic diagram of an example of the apparatus.

### DETAILED DESCRIPTION

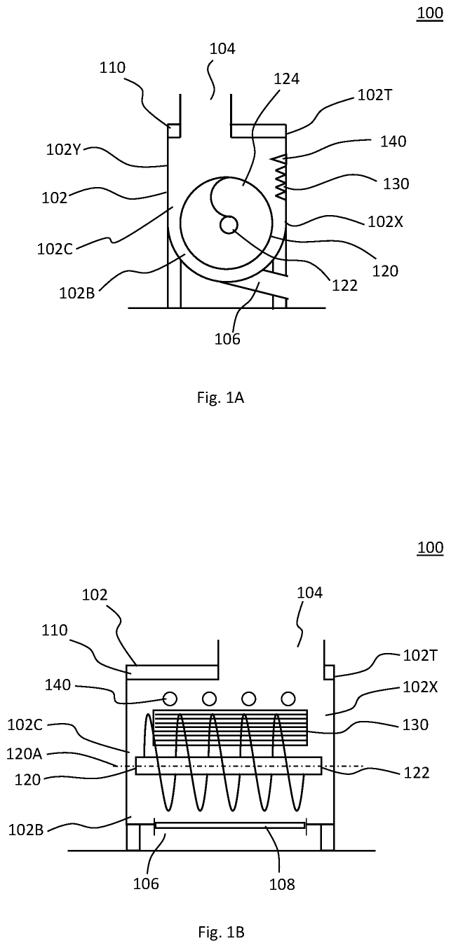

FIG. 1A shows a side sectional view of an example of an apparatus 100 for treating mixed waste. In the following examples, the apparatus 100 described is suitable for treating mixed waste that contains bioplastic material, paper material, etc. As shown in FIG. 1A, the apparatus 100 has an electromagnetic wave emitter 110 adapted to emit an electromagnetic wave on to the mixed waste, a movement inducing device 120 adapted to move the mixed waste when the electromagnetic wave is being emitted onto the mixed waste so that the mixed waste is moved to increase the exposure of the mixed waste to the electromagnetic wave, and at least one of a heat emitter 130 adapted to emit heat and a moisture emitter 140 adapted to emit moisture onto the mixed waste. Moving the mixed waste when emitting electromagnetic wave increases the exposure of the mixed waste to the electromagnetic wave so that the rate of degradation of the mixed waste may be increased to shorten the composting time of the mixed waste.

Apparatus 100 may include a chamber 102 with a top portion 102T, a bottom portion 102B opposite the top portion 102T and a centre portion 102C between the top portion 102T and the bottom portion 102B. Apparatus 100 may have an inlet 104 adapted to receive mixed waste into the chamber 102 and an outlet 106 adapted to release the mixed waste out of the chamber 102. As shown in FIG. 1A, the inlet 104 may be disposed at the top portion 102T of the chamber 102. Inlet 104 may be disposed directly above stirring device 120. Outlet 106 may be disposed at the bottom portion 102B of the chamber 102 and may be disposed below the movement inducing device 120. Electromagnetic wave emitter 110 may be disposed within the chamber 102 at the top portion 102T of the chamber 102. Movement inducing device 120 may be disposed within the chamber 102 at the centre portion 102C or bottom portion 102B of the chamber 102. As shown in FIG. 1A, the movement inducing device 120 may be disposed between the centre portion 102C and the bottom portion 102B of the chamber 102. At least one of the heat emitter 130 and moisture emitter 140 may be disposed within the chamber 102 and may be disposed at about the top portion 102T or centre portion 102C of the chamber 102. Both the heat emitter 130 and moisture emitter 140 may be mounted onto one side 102X of the chamber 102. Alternatively, the heat emitter 130 may be mounted onto one side 102X of the chamber 102 and the moisture emitter 140 may be mounted onto another side 102Y of the chamber 102 which is opposite of the heat emitter 130. Heat emitter 130 and/or the moisture emitter may be disposed at about the same level as the movement inducing device 120 so that the heat and/or moisture may be directed onto the moving mixed waste when the movement inducing device 120 is in operation. Alternatively, the heat emitter 130 and/or the moisture emitter may be disposed at a level that is at about the top portion 102T of the movement inducing device 120. It is also possible that the heat emitter 130 and/or the moisture emitter 140 is arranged to surround the movement inducing device 120 to direct heat and/or moisture on the mixed waste from all directions onto the mixed waste. By having the heat emitter 130 and the moisture emitter 140 arranged within the chamber 102, the heat and moisture may be emitted at the same time the mixed waste is being moved and exposed to the electromagnetic wave. In this way, the apparatus 100 can be more compactly designed and the treatment of the mixed waste may be expedited. It is also possible to emit the heat and moisture after the mixed waste has been treated by the electromagnetic wave.

Referring to FIG. 1A, the inlet 104 may be disposed at about one side, e.g. side 102Y of the chamber 102, opposite the another side, e.g. side 102X, such that the heat emitter 130 is disposed away from the inlet 104 to avoid possible direct heat exposure by a user who is pouring the mixed waste into the chamber 102 via the inlet 104.

FIG. 1B shows a frontal sectional view of an example of the apparatus 100. Referring to FIG. 1B, the movement inducing device 120 may rotate at about a rotational axis 120A. Movement inducing device 120 may extend from one end to another end of the chamber 102. Movement inducing device 120 may be a stirring device. As shown in FIG. 1B, the movement inducing device 120 may include a rotatable shaft 122 adapted to rotate about the rotational axis 120A and at least one stirring element 124 extending from the rotatable shaft 122, such that the stirring element 124 may be adapted to stir the mixed waste. Stirring element 124 may extend from the rotatable shaft 122 towards the sides 102X,102Y (not shown in FIG. 1B) of the chamber 102. Stirring element 124 may be a helical fin extending from the rotatable shaft 122 along the rotational axis 120A. Helical fin enables the mixed waste to be stirred and at the same time be transported along a direction parallel to the rotational axis 120A so as to increase the exposure of the mixed waste to the electromagnetic wave. Movement inducing device 120 may be a unitary element as shown in FIG. 1A. Movement inducing device 120 may include two or more elements disposed within the chamber 102. For example, the movement inducing device 120 may include at least two rotatable shafts, each with a stirring element extending therefrom. Movement inducing device 120 may be a rotatable drum adapted to contain the mixed waste such that the drum may be rotated to flip/toss the mixed waste. A plurality of fins may be attached to the internal surface of the drum to stir the mixed waste when the drum is rotating. Electromagnetic wave emitter may be disposed within the drum to emit electromagnetic wave onto the mixed waste as the drum rotates to flip/toss the mixed waste. Moving the mixed waste may include stirring, flipping, rotating, tossing or any action that allows the various parts of the mixed waste to be moved to be exposed to the electromagnetic wave. Apparatus 100 may include an outlet door 108 adapted to control the release of the mixed waste from the chamber 102.

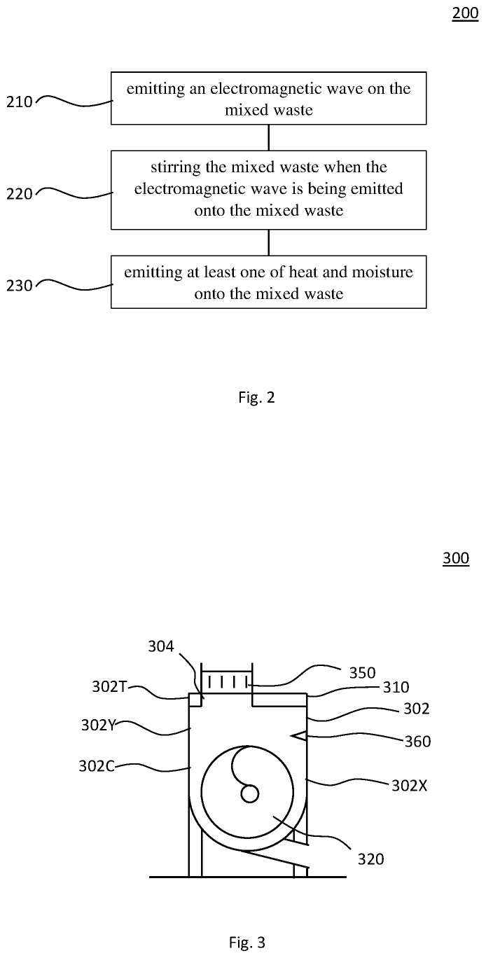

FIG. 2 shows a flow diagram of a method 200 for treating mixed waste. Method 200 may use the apparatus as shown in any one of the examples described here. Method 200 includes emitting an electromagnetic wave on the mixed waste in 210, moving the mixed waste when the electromagnetic wave is being emitted onto the mixed waste in 220 and emitting at least one of heat and moisture onto the mixed waste in 230. Moving the mixed waste increases its exposure to the electromagnetic wave. As mentioned earlier, moving the mixed waste may include stirring, flipping, rotating, tossing the mixed waste.

Referring to FIG. 1A, the mixed waste may be poured into the chamber 102 of the apparatus 100. In the chamber 102, the electromagnetic wave emitter 110 is adapted to be turned on to emit electromagnetic wave onto the mixed waste. At the same time, the mixed waste is moved or stirred to allow as much the mixed waste to be exposed to the electromagnetic wave as possible. As the mixed waste is being moved, heat and/or moisture are emitted from the heat emitter and/or the moisture emitter onto the mixed waste to allow thermal degrading and hydrolysis to take place in the mixed waste. After a predetermined period of time, the mixed waste may be extracted and discharged from the chamber 102 via the outlet 106 at the bottom of the chamber 102. Apparatus 100 may include a sensor to sense the presence of the mixed waste

Heat emitter 130 may be a heating element, e.g. heating coil, a heated air blower, etc. adapted to emit heat onto the mixed waste. Apparatus 100 may be adapted to emit heat to maintain the mixed waste at a temperature range from 60° C. to 100° C. Chamber 102 may be heated to 60° C. for thermal degradation of the mixed waste to take place. Chamber 102 may be heated up to 100° C. In an example, the heat emitter 130 may be adapted to emit heat to heat the mixed waste to a range of 60° C. to 85° C.

Referring to FIGS. 1A and 1B, the moisture emitter 140 may be a nozzle adapted to emit water vapour onto the mixed waste. Nozzle may be connected to a pressurized liquid source, e.g. a tank with a pump, and when operated, sprays moisture into the chamber 102. Apparatus 100 may be adapted to emit moisture to maintain the chamber 102 at a relative humidity from 70% to 100%. Relative humidity of the chamber 102 may be maintained at 80% to 100%, 75% to 95%.

FIG. 3 shows a side sectional view of an example of the apparatus 300. Features that are common in the embodiments in FIG. 1 and FIG. 3 have the same last two digits in their reference numbers. For example, the chamber 102 in FIG. 1 and chamber 302 in FIG. 3 have the same last two digits, i.e. 02. As shown in FIG. 3, the apparatus 300 may include a shredder 350 adapted to shred the mixed waste. Shredder 350 may be arranged to shred the mixed waste before channelling the mixed waste into the chamber 302. Shredder 350 may be connected to the chamber 302 via the inlet 304. Mixed waste may be poured into the shredder 350 to be shredded before being channelled into the chamber 302 via the inlet 304. Depending on the requirement and the type of mixed waste, the mixed waste may be shredded to a size of up to 50 mm long. Mixed waste may also be shredded to a size of up to 40 mm, 30 mm, 20 mm etc.

Referring to FIG. 3, the heat emitter and the moisture emitter may be combined as a pressurized heated moisture emitter 360 adapted to emit pressurized heated moisture onto the mixed waste. Instead of having the heated emitter and moisture emitter separately, the apparatus 300 may include a pressurized heated moisture emitter 360. Similarly, the pressurized heated moisture emitter 360 may be disposed at one side, e.g. side 302X, which is away from the inlet 304. Pressurized heated moisture emitter 360 may be disposed between the top portion 302T and the centre portion 302C of the chamber 302. Pressurized heated moisture emitter 360 may be connected to a pressurized heated liquid source (not shown in FIG. 3), e.g. a heated tank with a pump, where the heated liquid, e.g. water, may be pumped into the chamber 302 through the pressurized heated moisture emitter 360, e.g. as steam. For example, the pressurized heated moisture emitter 360 may be a steam nozzle adapted to emit steam into the chamber 302. By having the pressurized heated moisture emitter 360 instead of the heat emitter and moisture emitter separately, the space occupied by the former is less than that occupied by the latter. In this way, the chamber 302 may be smaller thus allowing the apparatus 300 to be more compactly designed.

Electromagnetic wave emitter 310 may be a UV emitter or any type of electromagnetic wave emitter that emits an electromagnetic wave that is suitable to degrade bioplastics. Electromagnetic wave emitter 310 be a UVC emitter. UV light is capable of degrading bioplastic. Electromagnetic wave may include a wavelength of 100-280 nm. Electromagnetic wave may include one of the following wavelengths: 10-400 nm, 100-290 nm. Electromagnetic wave emitter 310 may be arranged above and spaced from the movement inducing device 320 so that the emitter 310 would not be in contact with the mixed waste during treatment. For an UV emitter, e.g. UV lamp, it would be beneficial to keep the emitter clean so as to allow unobstructed transmission of the UV wave to the mixed waste. Electromagnetic wave emitter 310 may be disposed along one side, e.g. side 302X, and/or the another side, e.g. side 302Y, of the chamber 302. While it is not preferable to install the electromagnetic wave emitter 310 under the movement inducing device 320, it is possible to install the electromagnetic wave emitter under the movement inducing device 320. Apparatus 300 may be configured to have the electromagnetic wave emitter 310 surround the movement inducing device 320 to enable electromagnetic wave, e.g. UV wave, to be transmitted to the mixed waste. Apparatus 300 may be adapted to emit the electromagnetic wave onto the mixed waste for up to 12 hours. Alternatively, the electromagnetic wave emitter 310 may be adapted to emit the electromagnetic wave up to 6 hours, 7 hours, 8 hours, 9 hours, 10 hours or 11 hours. Chamber 302 may include a reflective internal surface adapted to reflect the electromagnetic wave. By having a reflective internal surface, the chamber 302 enables the electromagnetic wave to be channelled to the mixed waste in more than one direction thereby increasing the exposure of the mixed waste to the electromagnetic wave.

Apparatus 300 may include a controller (not shown in FIG. 3) adapted to control the apparatus 300. Controller may be connected to a sensor adapted to sense the presence of the mixed waste in the chamber 302 and to at least one of the following in the apparatus 300, e.g. electromagnetic wave emitter 310, movement inducing device 320, heat emitter (as shown in FIG. 1), moisture emitter (as shown in FIG. 1), outlet door (not shown in FIG. 3) and shredder 350. Apparatus 300 may also include a temperature sensor (not shown in FIG. 3) and a humidity sensor (not shown in FIG. 3) to detect the temperature and humidity in the chamber 302 respectively. Controller may be programmed to sense the input of the mixed waste in the chamber 302 and commence at least one of the following: emission of the electromagnetic wave, moving of the mixed waste, detecting the temperature and heating the mixed waste, moistening of the mixed waste and releasing of the mixed waste out of the chamber 302. For example, the controller may be adapted to enable the apparatus 300 to emit the electromagnetic wave, move the mixed waste, emit heat and/or moisture simultaneously. Apparatus 300 may also be configured to emit the heat and/or moisture after subjecting the mixed waste to electromagnetic wave and movement. A skilled person would appreciate that it is possible to configure the controller to carry out the steps in many permutations. In the example where the apparatus 300 emits the pressurized heated moisture, the controller may be adapted to control the temperature and amount of emission of the pressurized heated moisture, e.g. steam.

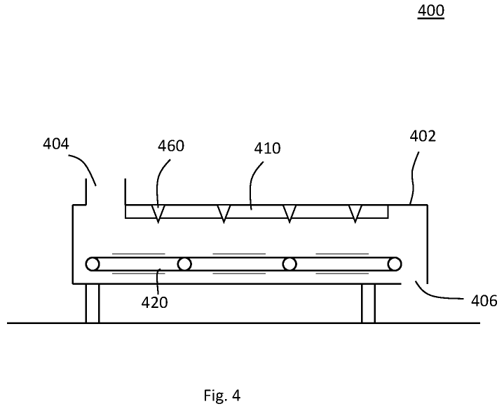

FIG. 4 shows a schematic diagram of an example of the apparatus 400. Apparatus 400 may include the chamber 402 having an inlet 404 and an outlet 406, the electromagnetic wave emitter 410, a movement inducing device 420. Movement inducing device 420 may be tossing/flipping device adapted to toss and/or flip the mixed waste. Apparatus 400 may include a pressurized heated moisture emitter 460. As mentioned earlier, the pressurized heated and moisture emitter 460 may be replaced by a separate heat emitter and a moisture emitter. Movement inducing device 420 may be a conveyor belt adapted to vibrate such that the mixed waste on the conveyor belt can be tossed about on the conveyor belt as the mixed waste is being transported along the length of the chamber 402. When the mixed waste is poured into the chamber 402, the mixed waste is being tossed and flipped by the vibrating conveyor belt and at the same time, the electromagnetic wave emitter 410 is emitting electromagnetic wave onto the mixed waste. While subjected to vibration, the mixed waste may be loosened and separated into smaller portions thereby increasing its exposure to the electromagnetic wave. In this way, the exposure of the mixed waste to the electromagnetic wave would be improved. Mixed waste may be discharged from the chamber 402 at the outlet 406 of the chamber 402.

As shown in all the examples above, the apparatus 100 may be compactly designed and is therefore suitable for places with space constraints, e.g. home, restaurant. In addition, by arranging the heat emitter and moisture emitter within the same chamber as the electromagnetic wave emitter and stirring device, the time taken to treat the mixed waste can be shortened. Further, by stirring the mixed waste while exposing the mixed waste to the electromagnetic wave allows the bioplastic material within the mixed waste to thereafter degrade faster. Apparatus may enable the food degradation or thermophilic digestion of the mixed waste to complete within 24 hours. Therefore, the apparatus of the present invention provides a compactly designed apparatus that allows fast treatment of the mixed waste.

A skilled person would appreciate that the features described in one example may not be restricted to that example and may be combined with any one of the other examples. For example, the shredder 350 as shown in FIG. 3 may be incorporated into the apparatus 400 in FIG. 4.

1. An apparatus for accelerating the degradation of mixed waste, the apparatus comprising:
a chamber adapted to contain the mixed waste;
an electromagnetic wave emitter disposed within the chamber, the electromagnetic wave emitter adapted to emit an electromagnetic wave on to the mixed waste;
a movement inducing device disposed within the chamber, the movement inducing device adapted to move the mixed waste when the electromagnetic wave is being emitted onto the mixed waste wherein the mixed waste is moved to increase the exposure of the mixed waste to the electromagnetic wave; and
at least one of a heat emitter adapted to emit heat and a moisture emitter adapted to emit moisture onto the mixed waste, wherein the at least one of the heat emitter and the moisture emitter are disposed within the chamber.

2. The apparatus of claim 1, wherein the movement inducing device comprises a rotatable shaft adapted to rotate about a rotational axis and at least one stirring element extending from the rotatable shaft, wherein the stirring element is adapted to stir the mixed waste.

3. The apparatus of claim 2, wherein the stirring element comprises a helical fin extending from the shaft along the rotational axis.

4. The apparatus of claim 1, wherein the heat emitter and the moisture emitter are combined as a pressurized heated moisture emitter adapted to emit pressurized heated moisture onto the mixed waste.

5. The apparatus of claim 1, wherein the electromagnetic wave emitter includes a UV emitter.

6. The apparatus of claim 1, wherein the electromagnetic wave has a wavelength of 100-280 nm.

7. The apparatus of claim 1, wherein the apparatus is adapted to emit the electromagnetic wave onto the mixed waste for up to 12 hours.

8. The apparatus of claim 1, wherein the apparatus is adapted to emit heat to maintain the mixed waste at a temperature range from 60° C. to 100° C.

9. The apparatus of claim 1, wherein the chamber comprises a top portion, a bottom portion opposite the top portion and a centre portion between the top portion and the bottom portion, wherein the electromagnetic wave emitter is disposed at the top portion of the chamber and the stirring device is disposed at the centre portion or bottom portion.

10. The apparatus of claim 9, wherein the chamber has a reflective internal surface adapted to reflect the electromagnetic wave.

11. (canceled)

12. The apparatus of claim 1, wherein moisture is emitted to maintain a relative humidity of 70% to 100% in the chamber.

13. The apparatus of claim 1, further comprising a shredder adapted to shred the mixed waste.

14. A method of accelerating the degradation of mixed waste in a chamber of an apparatus, the method comprising:
emitting an electromagnetic wave from within the chamber on the mixed waste;
moving the mixed waste when the electromagnetic wave is being emitted onto the mixed waste wherein moving the mixed waste increase its exposure to the electromagnetic wave; and
emitting at least one of heat and moisture onto the mixed waste from within the chamber.

15. The method of claim 14, wherein the emission of the heat and moisture is combined, wherein the method comprises emitting pressurized heated moisture.

16. The method of claim 14, wherein the electromagnetic wave is UV.

17. The method of claim 14, wherein the electromagnetic wave has a wavelength of 100-280 nm.

18. The method of claim 14, wherein the electromagnetic wave is emitted onto the mixed waste for up to 12 hours.

19. The method of any claim 14, wherein heat is emitted to maintain the mixed waste at a temperature range from 60° C. to 100° C.

20. The method of claim 14, wherein the apparatus comprises a chamber, wherein moisture is emitted to maintain the chamber at a relative humidity of 70% to 100%.

21. The method of claim 14, wherein the method further comprises shredding the mixed waste before emitting the electromagnetic wave and moving the mixed waste.
